(19) United States
(12) Patent Application Publication
(10) Pub. No.: US 2011/0063867 A1
(43) Pub. Date: Mar. 17, 2011

(54) Car lamp structure

(76) Inventor: Ming-Hsien Tsai, Tainan (TW)

(21) Appl. No.: 12/585,468

(22) Filed: Sep. 16, 2009

(51) Int. Cl. B60Q 1/00

(52) U.S. Cl. 362/538

(57) ABSTRACT

This invention relates to a car lamp structure which is essentially comprises a lamp seat and a lamp hood having reflection function; an actuation unit for switching between high-beam and low-beam being provided between the lamp seat and the lamp hood; a light emitting element being assembled on the lamp seat, and a convex lens for light convergence being provided on the lamp hood. With this structure, the light of car lamp can be converged by the convex lens having specific property, and the switching between high-beam and low-beam can be achieved by the light shield effect of the actuation unit. In this manner, multi-function having luminance change and light indication selection can be achieved.

### BACKGROUND OF THE INVENTION

1. Field of the Invention

The present invention relates to a car lamp, especially to a lamp used for car lighting in which an arrangement of light shield action achieved by the selection of high-beam and low-beam is provided on the passage of light beam coming from car lamp, such that a novel implementation having light indication selection and good line of vision for driving can be achieved.

2. Brief Description of Prior Art

Generally, projection lamp, car headlamp or fog lamp often use conventional tungsten filament light bulb or halogen light bulb. After long term use, traditional tungsten filament light bulb will age and its luster will change. When the bulb has aged, the output power of stabilizer has to be enlarged so as to maintain the stable power (35 W) for light bulb. Nowadays, the ballast design has a breakthrough on its predicament, in which the output power can be raised up to 43 W, depending on bulb requirement, so as to maintain the stability of light bulb. The halogen light bulb becomes very hot once it is lightened for a short period. Halogen lamp has advantages of cheaper price, longer lifetime, higher luminance and efficiency than that of the traditional tungsten filament lamp. However, operating at higher temperature is one of its disadvantages, as high temperature has negative effect on the lifetime of whole projection lamp.

Currently, some cars running on road at night emit whole white even blue-biased light, not only the light color is different from that of general car lamp but also its luminance is higher. In other word, these cars are equipped with so called “High-Intensity Discharge”, HID in short, which is almost the magnificent equipment ever equipped on deluxe models for recent years. Traditional halogen car lamp is one of incandescent lamps which emit light by generation of high temperature on tungsten filament after the passing through of electric current on it. In order to extend the lifetime determined by the evaporation of lamp filament, an inert gas and a small amount of halogen is filled into a quartz envelope in which the filament is sealed therein. The principle of HID lamp is to use gas discharge, in which xenon gas is filled into the quartz envelope and a super high electric voltage is then applied between tungsten electrodes housed therein so as to produce electric arc by gas discharge. Then, light is excited by electric arc.

Car without HID lamp has to adopt a new package to add with a HID lamp. As the HID lamp needs a central hole and a side hole for accommodating the lamp tube, the basic lamp structure of HID lamp is different from that of the traditional incandescent lamp which usually needs no side hole. Thus, the lamp seats required for these two light bulbs are different with each other. Therefore, cars having traditional projection lamp have to change the lamp seat of the headlamp into the lamp seat for HID lamp. Usually, it takes a lot of expense for this change.

In view of the above disadvantages, the inventor of this invention has proposed a car lamp structure based on contemplation and experiment in every ways according to modification and improvement conducted on above conventional structure, and by means of the assistance professional knowledge and profound experience, with a purpose to achieve the effectiveness of providing ample light during car driving.

### SUMMARY OF INVENTION

This invention relates to a car lamp structure the main object of which is to provide car driver with good and clear line of vision during driving.

In order to achieve above object, the car lamp structure of this invention essentially comprises a lamp seat and a lamp hood having reflection function, an actuation unit for switching between high-beam and low-beam being provided between the lamp seat and the lamp hood, a light emitting element being assembled on the lamp seat, and a convex lens enabling light convergence being disposed on the lamp hood. With this structure, the light of car lamp can be converged by the convex lens, and the switching between high-beam and low-beam can be achieved by the light shield effect of the actuation unit. In this manner, multifunction having luminance change and light indication selection can be achieved.

In the car lamp structure of the present invention, said actuation unit for switching between high-beam and low-beam comprises a support rod interlinked with a shield piece and driven by an electromagnetic valve. In this manner, selection of high-beam and low-beam can be achieved by the light shield effect of the actuation unit, and multifunction having luminance change and light indication selection can be achieved.

### BRIEF DESCRIPTION OF THE ACCOMPANYING DRAWINGS

FIG. 1 is a perspective exploded schematic view showing the car lamp structure of the present invention.

FIG. 2 is a sectional schematic view showing the car lamp structure of the present invention.

FIG. 3 is a schematic view (I) showing the action of the car lamp structure of the present invention.

FIG. 4 is a schematic view (II) showing the action of the car lamp structure of the present invention.

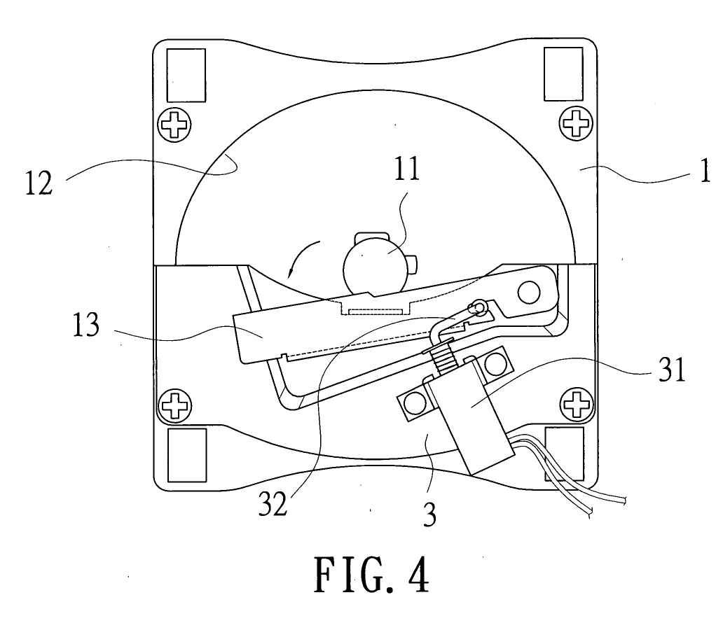

### DETAILED DESCRIPTION OF PREFERRED EMBODIMENT

The technical content, objects and effectiveness of the present invention will become more apparent by the detailed description of a preferred embodiment of the present invention in conjunction with the accompanying drawings.

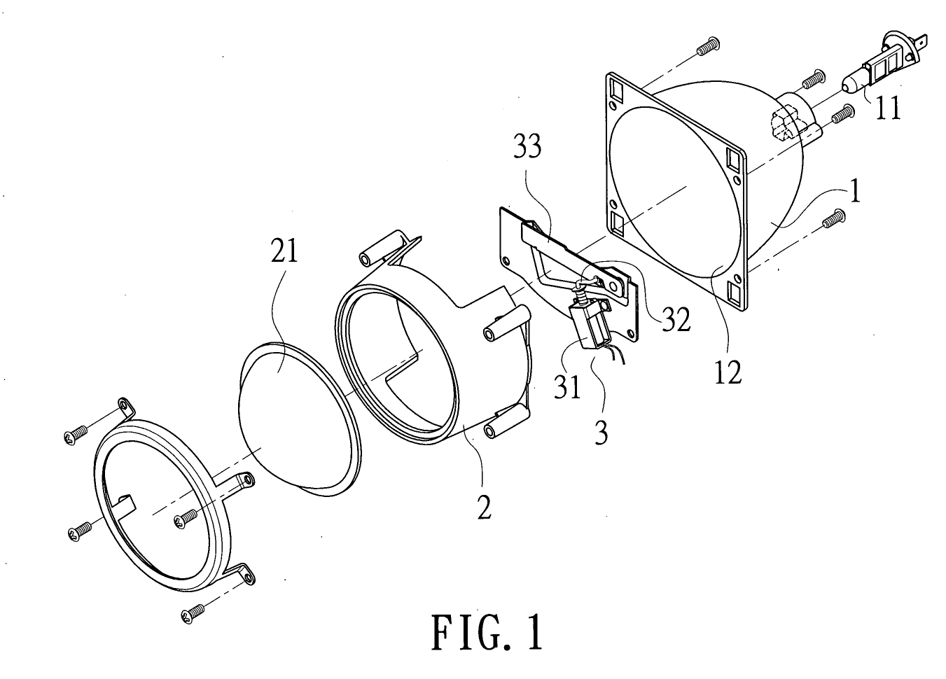

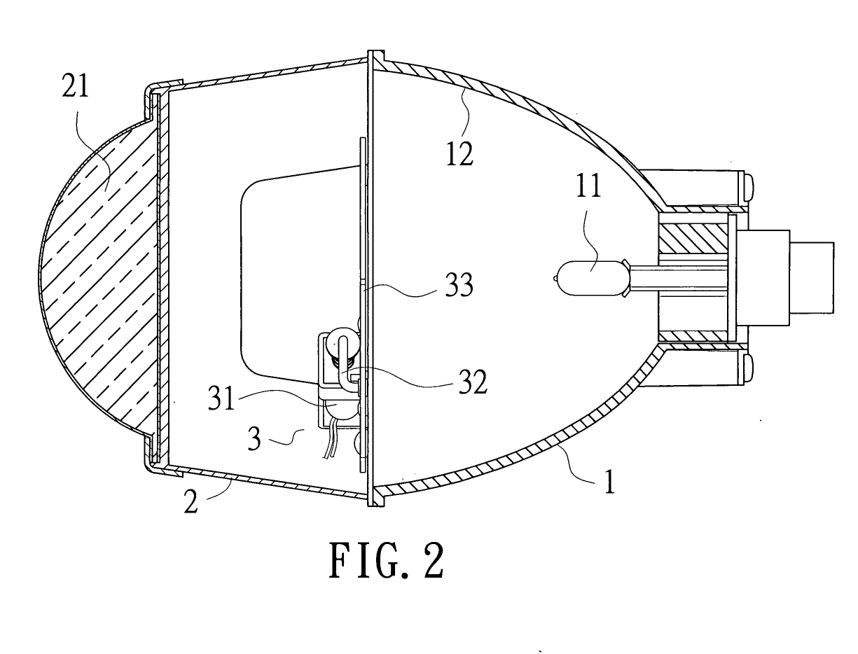

FIGS. 1 and 2 are perspective exploded view and sectional schematic views respectively of the car lamp structure of the present invention. As shown in these figures, the car lamp structure of the present invention comprises:

a lamp seat (1), the center of which is assembled with a light emitting element (11), and the inner peripheral side of which is formed with a reflection surface (12);

a lamp hood (2) provided at the front end surface of the light emitting element (11) of the lamp seat (1), a convex lens (21) enabling light convergence is provided at a place with respect to the light emitting element (11); and

an actuation unit (3) assembled between the lamp seat (1) and the lamp hood (2) and located at the lower half side, a support rod (32) interlinked with a shield piece (33) and driven by an electromagnetic valve (31) is provided therein.

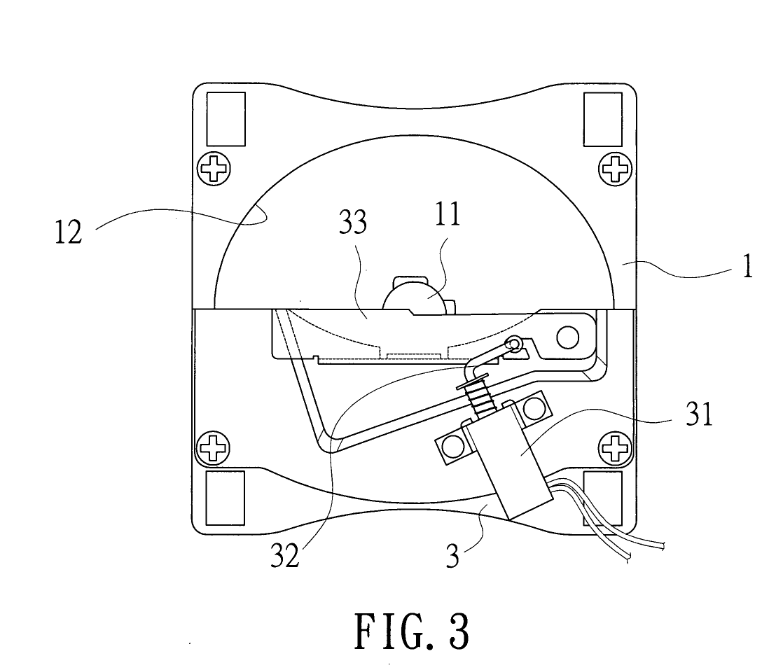

Referring to FIGS. 1 to 3, in assembling, the light emitted element (11) is assembled on the lamp seat (1) so that the light emitted from the light emitting element (11) can be reflected out by the reflection surface (12) in the interior of the lamp seat. In turn, an actuation unit (3) is assembled at the lower half side of the lamp seat (1) where light is irradiated out from the light emitting element (11). The actuation unit (3) has an electromagnetic valve (31) links up with a support rod (32) one end of which is interlinked with a shield piece (33). In turn, the lamp hood (2) is assembled at the front end of the lamp seat (1). A convex lens (21) enabling light convergence is provided on the lamp hood (2). In this manner, the car lamp can converge the light by means of the convex lens (21), and the selection of high-beam and low-beam can be achieved by slight-shield or non-shield action conducted on the light emitted from the light emitting element (11) by the shield piece (33), which is moved by the support rod (32) driven by the telescopic motion produced by the electromagnetic valve (31) of the actuation unit (3).

The above embodiment or drawings are not intended to restrict the structural aspect or dimension of the present invention. Variations of modifications made by the person having ordinary skill in the art without departing from the spirit and scope of the present invention are still regarded to be within the scope of the present invention.

Based on the foregoing, the car lamp structure of the present invention has the following advantages when comparing with the conventional structure.

1. In the car lamp structure of the present invention, the light emitted from the light emitting element provided in the car lamp is converged by means of a convex lens provided within the car lamp so that the effectiveness of ample illumination and clear line of vision during driving can be achieved.

2. In the car lamp structure of the present invention, the switching between high-beam and low-beam can be achieved by the light shield effect of the actuation unit provided in the car lamp. In this manner, multifunction having luminance change and light indication selection can be achieved.

What is claimed is:

1. A car lamp structure, essentially comprising: a lamp seat having a light emitting element mounted at the center and a reflection surface formed at its inner peripheral side; a lamp hood having a convex lens enabling light convergence, said lamp seat being combined with said lamp hood, wherein:
an actuation unit is assembled between said lamp seat and said lamp hood, said actuation unit being located at the lower half side where light is irradiated out from the light emitting element, said actuation unit using an electromagnetic valve to drive a support rod interlinking with a shield piece.
